(19) United States
(12) Patent Application Publication
(10) Pub. No.: US 2002/0078803 A1
(43) Pub. Date: Jun. 27, 2002

(54) Device for the machining of the ends of tubes for producing a welding joint

(75) Inventor: Erhard Weber, Frickenhausen (DE)

Correspondence Address: LAW OFFICE OF BARRY R LIPSITZ, 755 MAIN STREET, MONROE, CT, 06468, US

(73) Assignee: Wohlhaupter GmbH, Frickenhausen (DE)

(21) Appl. No.: 09/997,198

(22) Filed: Nov. 29, 2001

Related U.S. Application Data
(63) Continuation of application No. PCT/EP00/04583, filed on May 20, 2000.

(30) Foreign Application Priority Data
Jun. 12, 1999 (DE) 199 26 829.0

(51) Int. Cl. B23B 5/16; B23B 13/00

(52) U.S. Cl. 82/113; 82/128

(57) ABSTRACT

In order to further develop a device for the machining of the ends of tubes for producing a welding joint comprising a housing which can be secured on the end of the tube to be machined and on which a rotatingly drivable shaft is mounted, and comprising a rotary unit non-rotatably arranged on the shaft with a radially adjustable tool slide, on which a cutting plate is held, in such a manner that the welding joint can be produced in a shorter machining time and with a high-standard surface quality it is provided in accordance with the invention for the tool slide to be adjustable continuously in a radial direction, wherein the radial adjustment of the tool slide is coupled to the rotary movement of the shaft via gear means, and for the cutting plate to be held on the tool slide so as to be adjustable axially, parallel to the longitudinal axis of the shaft.

The present disclosure relates to the subject matter disclosed in International Application No. PCT/EP00/04583 (WO 00/76701) of May 20, 2000, which is incorporated herein by reference in its entirety and for all purposes.

### BACKGROUND OF THE INVENTION

The present invention relates to a device for the machining of the ends of tubes for producing a welding joint comprising a housing, which can be secured on the tube to be machined and on which a rotatingly drivable shaft is mounted, and comprising a rotary unit non-rotatably arranged on the shaft with a tool slide which can be adjusted radially, transversely to the longitudinal axis of the shaft, and on which a cutting plate is held for removing material from the front end of the tube.

Devices of this type are used when the front end of a tube, for example, a metal tube is intended to be provided with a welding joint so that the tube can be welded to an additional tube, thereby forming a connecting seam. The tubes customarily serve for the transport of the most varied of liquid or gaseous mediums, whereby it is intended to be ensured that no escape of medium occurs at the welding seams.

The most varied joint shapes are known for the welding joint required for generating a welding seam of a qualitatively high standard, for example, I-shaped joints, V-shaped, Y-shaped and U-shaped joints with different angles of flank inclination. To generate joints of this type, devices are known, with which a housing can be secured on the end of the tube to be machined by means of a clamping unit. A rotatable shaft is mounted in the housing and with its help a rotary unit can be caused to rotate, wherein a tool holder with a cutting plate is held on the rotary unit. The cutting plate is normally in engagement with the front end of the tube over the entire cutting length, i.e. a chamfering operation takes place. The axial advancing of the cutting plate is brought about manually via an advancing wheel. The manual advancing controls the chip breakage and therefore also the cutting stoppage time as well as the necessary machining time. The production times for a chamfering operation are, on average, more than seven hours, wherein the surfaces generated on the ends of the tubes have only a low surface quality on account of chatter marks occurring.

Devices for machining the ends of tubes for producing a welding joint are also known, with which the tool slide is mounted on the rotary unit so as to be radially adjustable so that the end of the tube can be radially turned. The radial adjustment of the tool slide is brought about manually; this results in a considerable machining time. Moreover, in the case of such devices the cutting plate is aligned at a predetermined cutting angle and secured on the tool slide in this orientation. If the orientation of the cutting plate is intended to be changed in order to vary the set angle and thus the shape of the welding joint in this way, the rotary unit must be stopped for this purpose in order to alter the inclination of the cutting plate manually. This also results in an increase in the machining time.

It is the object of the present invention to develop a device of the generic type further in such a manner that a welding joint can be produced in a shorter machining time with a surface quality of a qualitatively high standard.

### SUMMARY OF THE INVENTION

This object is accomplished in accordance with the invention, in a device of the type specified at the outset, in that the tool slide can be adjusted continuously in a radial direction, wherein the radial adjustment of the tool slide is coupled to the rotary movement of the shaft via gear means, and that the cutting plate is held on the tool slide so as to be adjustable axially, parallel to the longitudinal axis of the shaft.

A continuous rotary operation is brought about by means of the inventive device in that the tool slide and the cutting plate held on it perform an uninterrupted radial movement. The front end of the tube to be machined is thereby turned. This makes particularly economic operating values possible, namely rotational speeds of, for example, 10 to 50 revolutions per minute and advancing values of approximately 0.15 mm per revolution. As a result, considerably shorter operating times may be achieved, for example, machining times of one to two hours. Moreover, a surface of a qualitatively high standard and exact in shape can be generated by the rotary operation.

An additional advantage of the inventive device is to be seen in the fact that the cutting plate is held on the tool slide so as to be adjustable in axial direction. This makes it possible to achieve the most varied of welding joint shapes in that the axial position of the cutting plate is altered. Such an alteration may take place, in particular, during the rotational movement of the rotary unit and the radial movement of the tool slide without the device having to be stopped for this purpose. This also results in a considerable reduction in the machining times required.

It is of particular advantage when the device has a copying unit which forms an automatic guide means for the cutting plate. A predetermined movement can be imposed on the cutting plate by means of the copying unit as a function of the radial position of the tool slide in axial direction so that the cutting plate alters its positioning during the radial movement of the tool slide depending on the desired shape of the joint. The desired contour of the front end of the tube can thus be generated by way of copy turning. The copy turning has the particular advantage that the most varied of variations in the shape of the welding joints can be generated by means of a quick change of the copying unit. In this respect, the same respective cutting plate can be used; for a change in the shape of the welding joint only the copying unit need be interchanged by an operator. For this purpose, it is favorable when the copying unit is held on the rotary unit so as to be interchangeable.

It is favorable when the cutting plate is held on the copying unit so as to be interchangeable so that this can be interchanged independently of the copying unit.

In a preferred embodiment it is provided for the tool slide to have a sliding guide means, along which the cutting plate is displaceable in axial direction. A dovetail guide means can, for example, be used for holding the cutting plate on the tool slide. It is, however, particularly favorable when the sliding guide means comprises groove teeth, i.e. the facing surfaces of the tool slide and of a cutting plate holder provided for holding the cutting plate on the tool slide each have teeth and engage in one another with these teeth. This allows a particularly simple handling, in particular, during the interchanging of the cutting plate.

The radial adjustment of the tool slide is preferably brought about such that the tool slide is held on a spindle rotatingly drivable by the shaft so as to be radially displaceable. The spindle is preferably aligned transversely to the longitudinal axis of the shaft and the drive of the spindle can, for example, be brought about via bevel gears or a worm gearing.

In order to reduce the machining time further, it is provided in a particularly preferred embodiment of the inventive device for the gear means used for coupling the radial movement of the tool slide to the rotary movement of the shaft to comprise a switching unit for selectively switching the radial movement of the tool slide between a forward movement during the machining of the end of the tube and a rapid return movement for returning the tool slide into its initial position. The rotary operation is preferably brought about radially from the outside towards the inside and the advancing of the tool slide with the cutting plate following a successful radial movement is brought about via the rapid return movement and a subsequent axial advancing of the housing held on the tube to be machined so as to be adjustable for this purpose in axial direction, wherein a feed movement of approximately 0.15 mm is normally brought about. The number of radial movements or cuts required depends, in particular, on the desired shape of the joint. In any case, a considerable reduction in the machining time is, however, achieved via the rapid return movement.

In order to switch over between forward movement and rapid return movement, the switching unit preferably has a manually actuatable switching lever.

In this respect, it is favorable when a neutral position is provided, in addition, which is characterized by the fact that the tool slide is not in drive connection with the shaft. This makes a machining of the outer side or inner side of the tube possible since, in the neutral position, the radial movement of the tool slide is interrupted and so when the rotational movement of the rotary unit and, at the same time, axial advancing movement of the device, for example, by means of a crank handle are maintained, the inner diameter of the tube can be turned or its outside diameter turned.

It may be provided for the tool slide to be manually adjustable in the neutral position, for example, by means of a crank handle which can be placed on the spindle radially from the outside or a regulator wheel.

A further reduction in the machining time may be achieved due to the fact that the switching unit comprises a control device which can be actuated automatically by the tool slide upon reaching its end position. If the tool slide has performed a radial movement, for example, from the outside towards the inside and reached its end position, it thereby actuates the control device, with the aid of which the switching unit is switched into the rapid return movement and thus the tool slide is automatically returned to its initial position after carrying out a radial movement.

The control device may be designed, for example, as a pivotable control disk, for example, in the form of a cam disk or a pivotally mounted transmission lever.

The inventive device may be used for the most varied of tube diameters and tube wall thicknesses. It may, for example, be provided for tube diameters of approximately 200 mm to approximately 610 mm to be machined by means of the inventive device, wherein tube wall thicknesses of up to approximately 60 mm can be used.

Different tube wall thicknesses make a different path of adjustment of the tool slide necessary. This may preferably be set manually. For this purpose, it may be provided, for example, for at least one stop to be held on the tool slide, on which the control device can abut for actuating the switching unit and which is held so as to be adjustable for setting the path of adjustment of the tool slide. The stop can thus be set accordingly depending on the desired path of adjustment, wherein, for this purpose, a scale is preferably arranged on the tool slide. The tool slide can also be set manually to the desired tube diameter in a simple manner by means of this scale. If the tool slide has reached its end position after carrying out a radial movement, the stop hereby butts against the control device so that the forward movement of the tool slide is terminated by means of the switching unit and, instead, the rapid return movement is switched on.

In an embodiment having a particularly compact construction, it is preferably provided for the gear means to comprise a planetary gearing with a planet pinion for driving the tool slide as well as a coupling unit for coupling the rotary movement of the shaft to the movement of the planetary gearing. Such a configuration makes a construction possible, with which the rotatory movement of the planet pinion corresponds to the rotational movement of the rotary unit while the actual rotation of the planet pinion can be utilized for driving the tool slide. For this purpose, it may, for example, be provided for the planet pinion to be coupled via bevel gears to the spindle used for the radial movement of the tool slide.

The planetary gearing preferably comprises a rotatably arranged hollow wheel, along which the planet pinion rolls and which can be driven by the shaft via the coupling unit. In this respect, a toothed wheel non-rotatably held on the shaft can be used between shaft and coupling unit, wherein the toothed wheel is arranged in a particularly preferred manner parallel to the plane of rotation of the planet pinion. Such a configuration facilitates a configuration which is of a very compact construction particularly in axial direction since the gear means in the form of the planetary gearing, the toothed wheel and the coupling unit connecting these to one another only require a little space in axial direction.

In order to generate a forward motion of the tool slide, the coupling unit preferably comprises a pair of gear wheels with first and second gear wheels which can be coupled to one another and are in operative connection with the shaft and the planetary gearing, respectively. The rotary movement of the shaft can be transferred to the planetary gearing in a constructionally simple manner by means of the pair of gear wheels.

If a rapid return movement is provided in addition to the forward motion of the tool slide, it is favorable when the coupling unit also has an additional pair of gear wheels with first and second gear wheels which can be coupled to one another and which are in operative connection with the shaft and with the planetary gearing, respectively, wherein an intermediate gear wheel is used in the case of one of the gear wheels for the operative connection. The use of the intermediate gear wheel makes a reversal of the direction of rotation possible and thus a reversal of the direction of movement of the tool slide. Moreover, by selecting the transmission ratio between the intermediate gear wheel and the corresponding gear wheel the speed of the rapid return movement of the tool slide can be predetermined.

If the movement of the tool slide during the machining of the end of the tube is blocked unintentionally, it is of advantage when the gear wheels of the pair of gear wheels can be coupled to one another via an overload coupling, wherein the overload coupling releases the coupling of the two gear wheels when an overload occurs during the adjustment of the tool slide. As a result, damage to the gear means is prevented during any blocking of the tool slide.

In one particularly advantageous embodiment of the inventive device, it is provided for the gear wheels of the pair of gear wheels to be arranged axially one behind the other, wherein one gear wheel is arranged so as to be axially adjustable and can be brought to a distance from the corresponding gear wheel. Such a configuration makes the neutral position of the tool slide explained above possible in that the transfer of the rotary movement of the shaft to the planetary gearing is interrupted. For this purpose, it is merely necessary to bring the two gear wheels of the pair of gear wheels to a distance from one another so that a coupling between the two gear wheels is no longer present.

It is particularly favorable when not only the two gear wheels of the pair of gear wheels used for generating the forward motion but also the two gear wheels of the pair of gear wheels used for generating the rapid return movement are respectively arranged axially one behind the other, wherein one respective gear wheel can be axially adjusted and brought to a distance from the corresponding gear wheel. This makes it possible to alternatively couple the respective gear wheels of one pair of gear wheels to one another, wherein a neutral position is present between the respective coupled positions and in this position the gear wheels of both pairs of gear wheels are arranged at a distance from one another.

The axial adjustment of the gear wheels may be brought about, for example, by means of a rocker arm.

A drive unit which is arranged in the housing of the device is preferably provided for driving the shaft. In this respect, a compressed air motor or an electric motor may, for example, be used.

In a particularly preferred configuration it is provided for at least two tool slides each with a cutting plate to be held on the rotary unit so as to be radially adjustable. As a result, the time for the machining of an end of a tube may be reduced, in addition. Moreover, the machining with at least two cutters makes a reciprocal supporting of the cutting plates possible and thus a balancing of the cutting forces occurring. This results, on the other hand, in an improvement in the surface quality of the welding joint.

It is favorable when the housing of the device can be fixed on the end of the tube so as to be axially biased contrary to the action of a spring force. The housing and the shaft with the rotary unit arranged thereon and the tool slide may, as a result, be biased in axial direction. For this purpose, a spring element is provided, for example, a helical spring or a cup spring guide. As a result of such an axial biasing it is ensured that the cutting plate held on the tool slide is not drawn in the direction towards the front end of the tube to be machined during the removal of material and, as a result, the rotational movement of the rotary unit being blocked.

The housing of the inventive device is held on a so-called “mast” in the customary manner so as to be axially adjustable, this mast being secured on the tube to be machined via a wedge mechanism known per se. As already explained, the housing is advanced in axial direction following a completed radial movement of the tool slide. In this respect, it is favorable when a motor drive is provided for the axial advancing movement of the housing. For this purpose, a separate drive motor may be used; however, it may also be provided for the compressed air or electric motor used for driving the shaft to also bring about the advancing movement of the housing via additional gear means.

The following description of a preferred embodiment of the invention serves to explain the invention in greater detail in conjunction with the drawings.

### BRIEF DESCRIPTION OF THE DRAWINGS

FIG. 1: shows a partial cutaway front view of a device for the machining of the ends of tubes for producing a welding joint;

FIG. 2: shows a sectional view along the line 2-2 in FIG. 1;

FIG. 3: shows a partial sectional view of the device in the area of a coupling unit used;

FIG. 4: shows a sectional view along line 4-4 in FIG. 3;

FIG. 5: shows an enlarged front view of a section of a rotary unit used with a tool slide in its initial position;

FIG. 6: shows a view in the direction of arrow A from FIG. 5;

FIG. 7: shows an enlarged front view corresponding to FIG. 5 with the tool slide in its end position;

FIG. 8: shows a sectional view along line 8-8 in FIG. 5:

FIG. 9: shows a sectional view along line 9-9 in FIG. 5;

FIG. 10: shows a side view of a copying unit used alternatively with the device, with a cutting plate support and a cutting plate;

FIG. 11: shows a view in the direction of arrow B from FIG. 10 and

FIG. 12: shows a side view of an additional alternative copying unit with the cutting plate support and cutting plate.

### DETAILED DESCRIPTION OF THE INVENTION

In the drawings, a device for the machining of the ends of tubes for producing a welding joint, which has been given altogether the reference numeral 15, is illustrated. This comprises a housing 17 with a longitudinal bore 19 of a stepped design and a drive unit 21 with a compressed air motor 22 which is illustrated only schematically in the drawings, is known per se and has a drive shaft 23 with a drive wheel 24 designed as a bevel gear.

The longitudinal bore 19 has a mast 26 passing through it which is known per se and therefore illustrated only schematically in the drawings and which dips with its free end 27 facing away from the housing 17 into a tube 28 to be machined and bears a wedge mechanism 29 which is likewise known, is illustrated only schematically in the drawings and has three clamping jaws 30 arranged so as to be evenly distributed in circumferential direction. The mast 26 may be introduced into the tube 28 in a customary manner and, subsequently, the mast 26 may be clamped with the tube 28 on the inner side. This clamping is not the subject matter of the present invention. It is, however, of significance that the mast 26 is surrounded by a spiral spring 32 adjacent to the wedge mechanism 29. The housing may be axially biased contrary to the action of the spiral spring 32 in the direction towards the tube 28, as will be explained in greater detail in the following.

The mast 26 passes through an axial through bore of a shaft 36 which is mounted in the housing 17 for rotation by means of ball bearings 34, 35, widens in the direction towards the free end 27 of the mast 26 in the shape of a truncated cone and in this area bears bevel teeth 38 which mesh with the drive wheel 24.

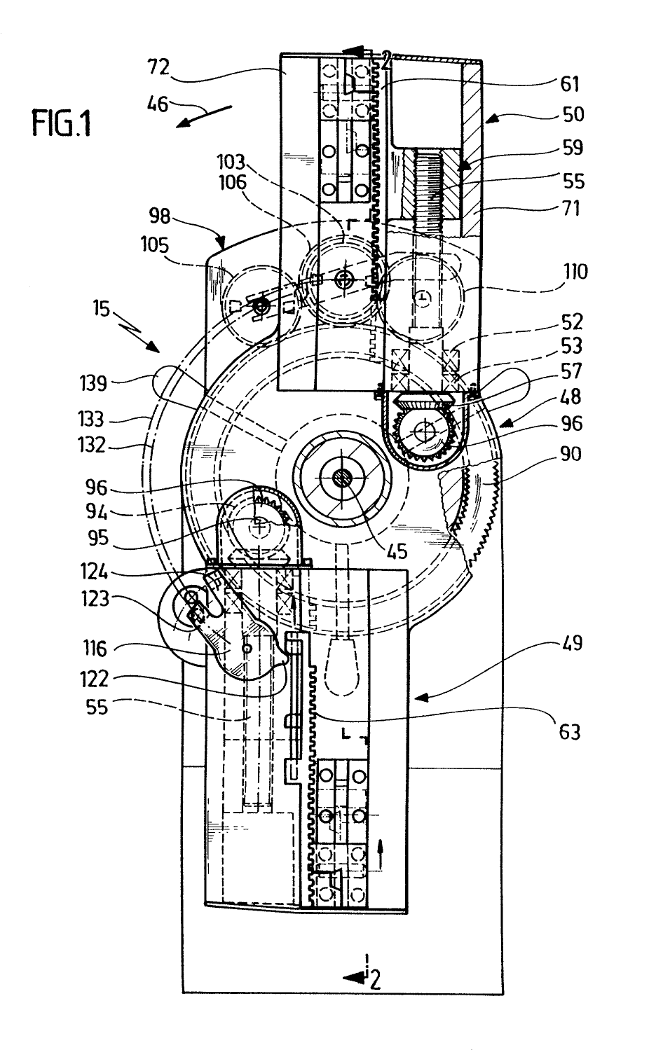

On its front end facing the tube 28 to be machined, the shaft 36 bears a rotary unit 42 with a toothed wheel 40 arranged in between, wherein a rear wall 43 of the rotary unit 42 is screwed to the shaft 36 together with the toothed wheel 40. If the shaft 36 is thus caused to rotate by the compressed air motor 23 due to engagement of the drive wheel 24 in the bevel teeth 38, this results in a rotation of the rotary unit 42 about the longitudinal axis 45 of the shaft 36, which is outlined in FIG. 1. Moreover, the toothed wheel 40 screwed to the shaft 36 is likewise caused to rotate with the rotation of the shaft. The rotational movement of the rotary unit 42 and the toothed wheel 40 is symbolized in FIG. 1 by the arrow 46.

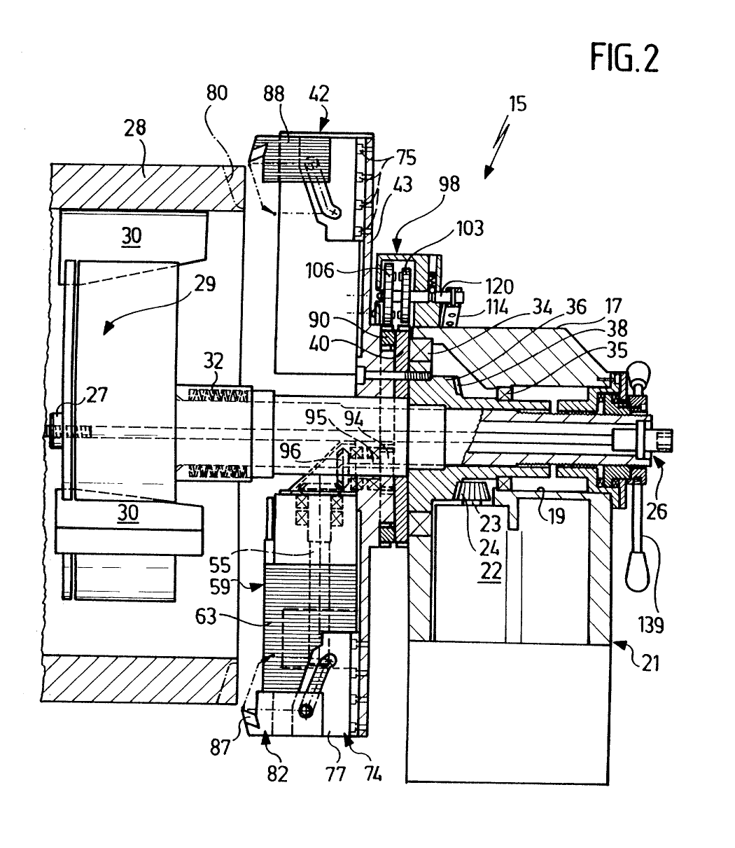

As is clear, in particular, from FIGS. 1 and 2, the rotary unit 42 comprises a central part 48 which is essentially of a circular-cylindrical design and from which two rotary vanes 49, 50 of an identical design project, aligned transversely to the longitudinal axis 45 of the shaft 36 and facing away from one another. A rotary spindle 55, which bears a bevel gear 57 at its end facing the central part 48, is mounted for rotation in each of the rotary vanes 49, 50 by means of ball bearings 52, 53. The rotary spindle 55 is in engagement with a tool slide 59 which is arranged in the rotary vane 49 and 50 for displacement and, for this purpose, has an internal thread corresponding to the external thread of the rotary spindle 55. If the rotary spindle 55 is caused to rotate due to rotation of the bevel gear 57, this results in a displacement of the tool slide 59 in a radial direction, i.e. transversely to the longitudinal axis 45. In FIG. 1, the tool slide is illustrated by solid lines in its initial position, i.e. radially outwards, and the tool slide 59 is illustrated in its end position radially inwards by dashed lines.

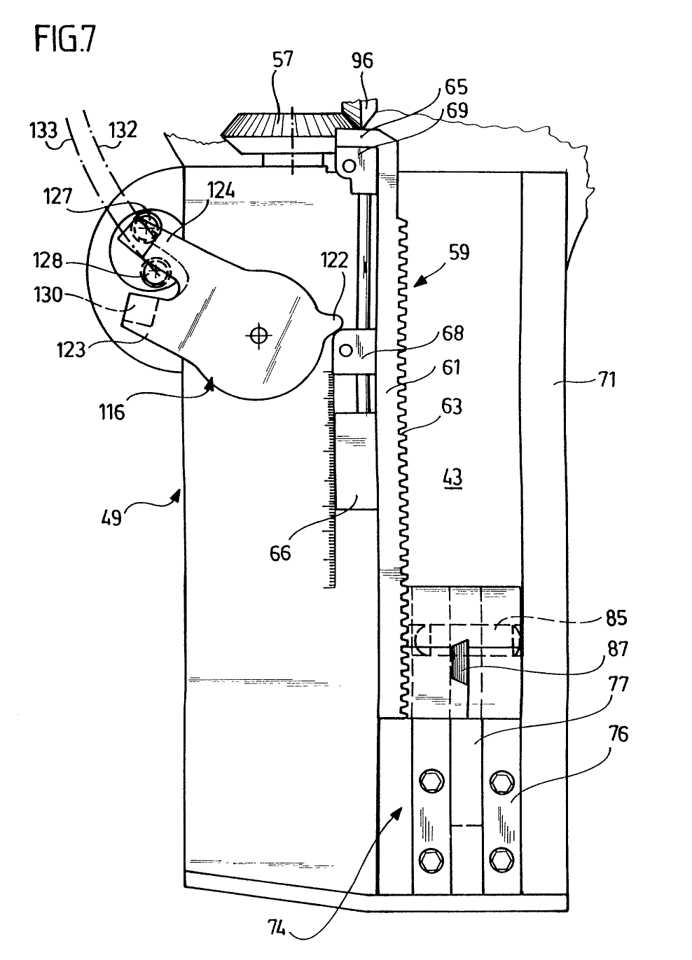

The tool slide 59 bears at a distance from the rotary spindle 55 a receiving plate 61 which is designed in one piece with it and has on its upper side facing away from the rotary spindle 55 groove teeth 63 aligned parallel to the longitudinal axis 45. This is clear, in particular, from FIGS. 5 and 7.

Facing away from the groove teeth 63, the receiving plate 61 bears on its underside at a distance from one another two holding angles 65, 66 which accommodate between them a guide rail 67, on which end stops 68 and 69 located radially outwards and radially inwards are held so as to be adjustable.

The rotary vanes 49, 50 are essentially of a U-shaped configuration in that side walls 71, 72 project from the rear wall 43 of the rotary unit 42, these side walls being aligned parallel and at a distance from one another and forming between them a space, in which the tool slide 59 is held for displacement.

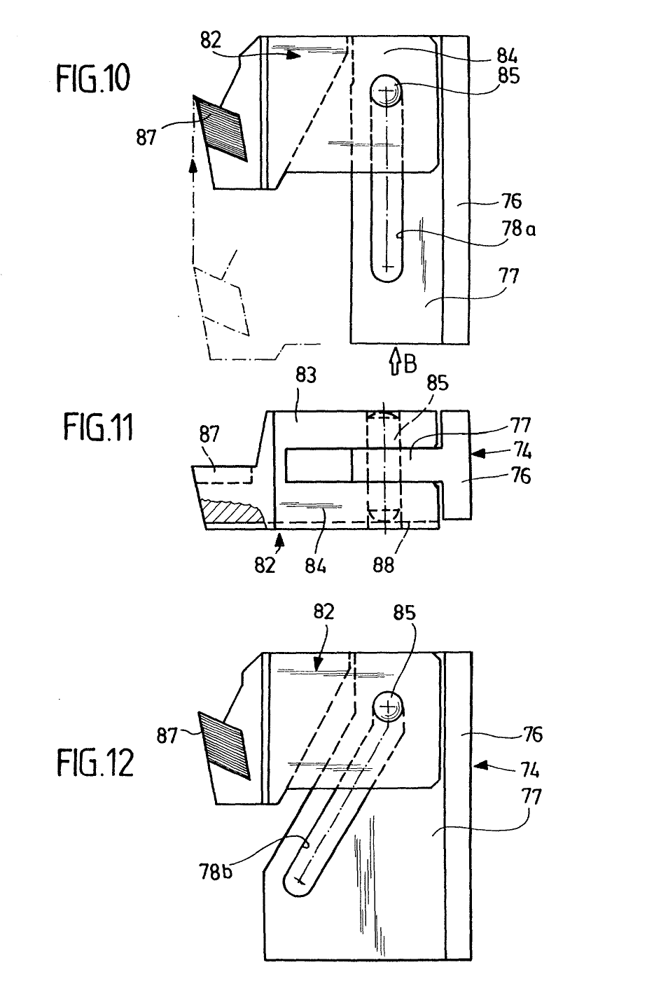

A copying unit 74 is screwed to the rear wall 43 by means of screws 75 between the side walls 71 and 72, adjacent to the receiving plate 61 of the tool slide 59. The copying unit 74 comprises a holding plate 76 which rests on the rear wall 43 and from which a guide plate 77 projects at right angles. The latter has a through bore in the form of an elongated hole 78, wherein the configuration of the elongated hole 78 corresponds to the shape of the welding joint 80 to be produced. This is illustrated in FIG. 2 by a dash-dot line. Copying units with alternative configurations of the elongated hole 78 in the form of the elongated holes 78a and 78b are illustrated in FIGS. 10 to 12. A cutting plate support 82 is seated on the guide plate 77 and this is essentially of a U-shaped design with two arms 83, 84 aligned parallel to one another, as is clear, in particular, from FIG. 11. The two arms 83, 84 accommodate the guide plate 77 of the copying unit 74 between them and are held for displacement on the guide plate 77 by means of a guide bolt 85 which engages through the elongated hole 78 of the holding plate 76 and is secured in through bores of the two arms 83, 84.

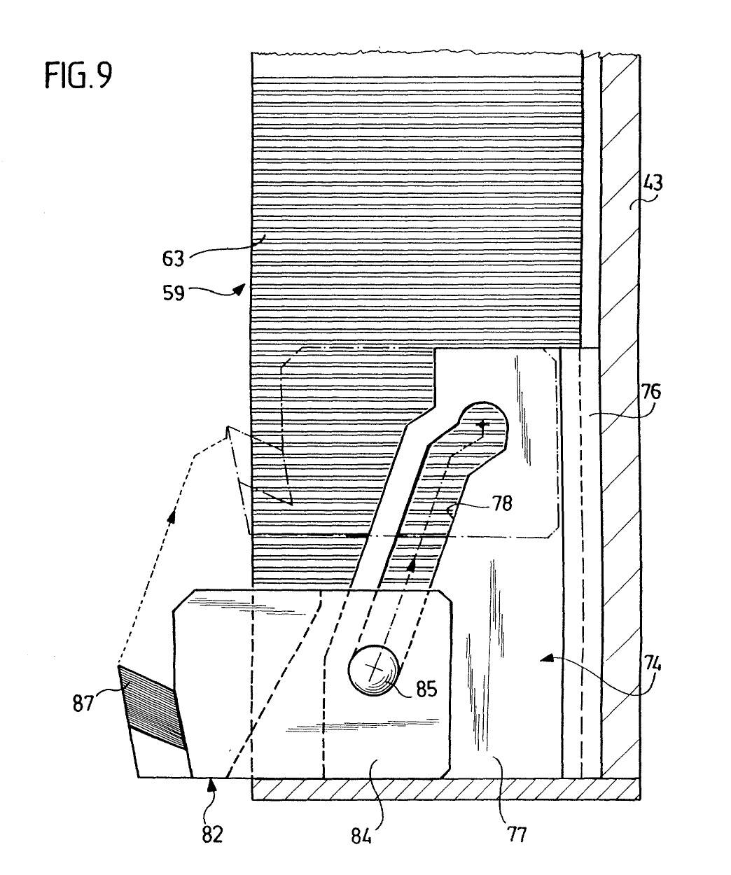

A cutting plate 87 is held on the cutting plate support 82 in a manner known per se and therefore not illustrated in the drawings so as to be interchangeable. The arm 84 of the cutting plate support 82 facing the receiving plate 61 of the tool slide 59 bears teeth corresponding to the groove teeth 63 of the receiving plate 61, as is apparent, in particular, from FIGS. 2 and 11. The radial movement of the tool slide 59 is transferred via these teeth 88 to the cutting plate support 82 held for displacement on the copying unit 74. This results in the cutting plate support 82 likewise being moved in a radial direction during a radial movement of the tool slide 59. Depending on the configuration of the elongated hole 78, a movement in axial direction, i.e. along the groove teeth 63, is thereby imposed, in addition, on the cutting plate support held on the tool slide 59 for displacement in axial direction. This is clear, for example, from FIG. 9. The elongated hole 78 thus forms an automatic guide means for the cutting plate support 82 in combination with the guide bolt 85.

As already explained, the rotational movement of the rotary unit 82 is driven by means of the shaft 36. In addition, the tool slide 59 is driven to perform a radial movement via the shaft 36. For this purpose, the gear wheel 40 is used, on the one hand, and, on the other hand, a planetary gearing is arranged in axial direction between the gear wheel 40 and the rotary unit 42 and has a hollow wheel 90, which is rotatable about the longitudinal axis 45 and has outer teeth 91 as well as inner teeth 92, as well as two planet pinions which roll along the inner teeth 92 of the hollow wheel 90 and are respectively associated with the rotary spindle 55 of one rotary vane 49 or 50, wherein only one planet pinion 94 is illustrated in the drawings (FIGS. 1 and 2). Each of the planet pinions 94 is non-rotatably seated on a planet pinion support shaft 95 which bears at its end facing away from the planet pinion 94 a bevel gear 96 which meshes with the bevel gear 57 which is non-rotatably connected to the rotary spindle 55.

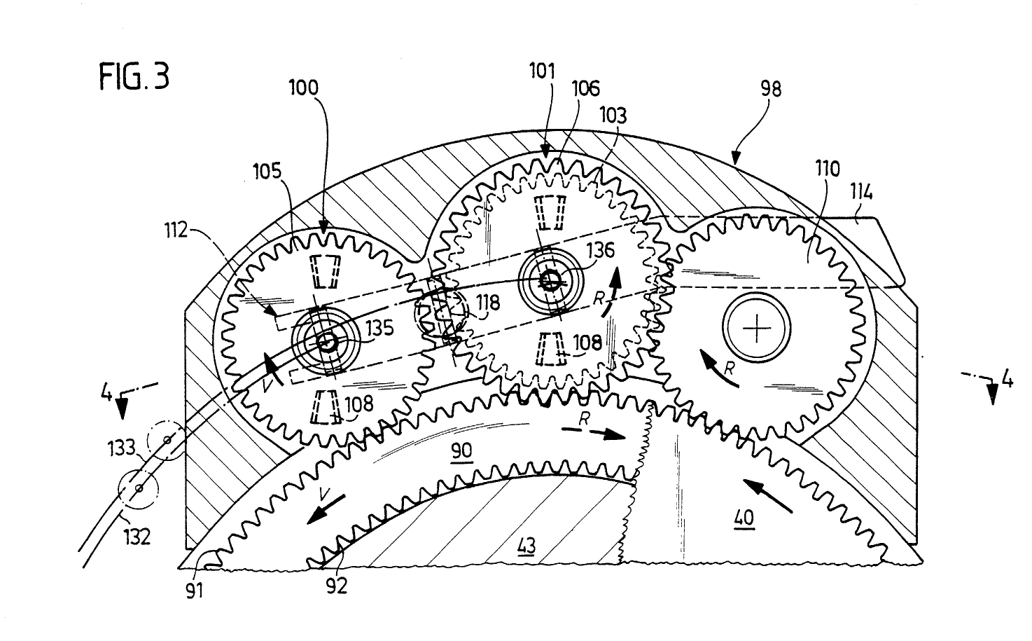

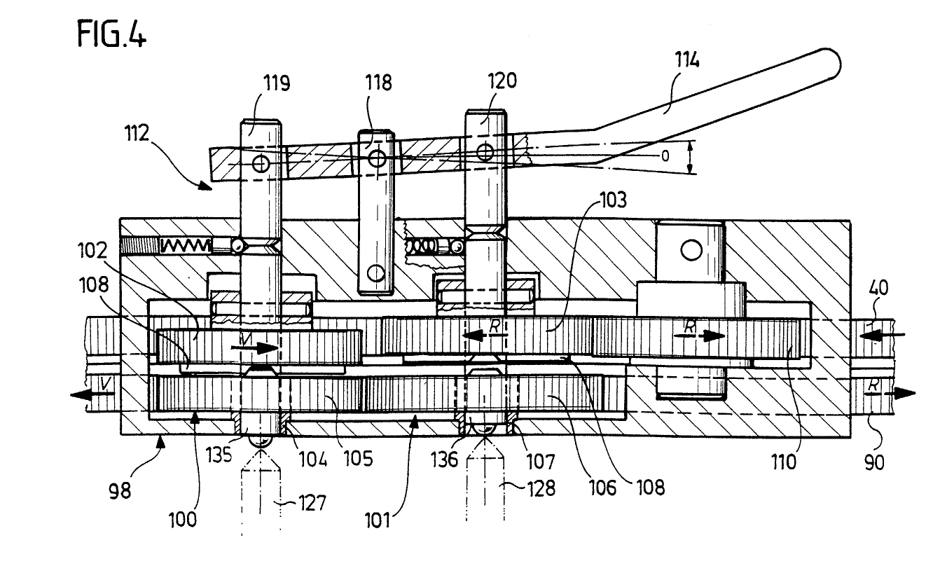

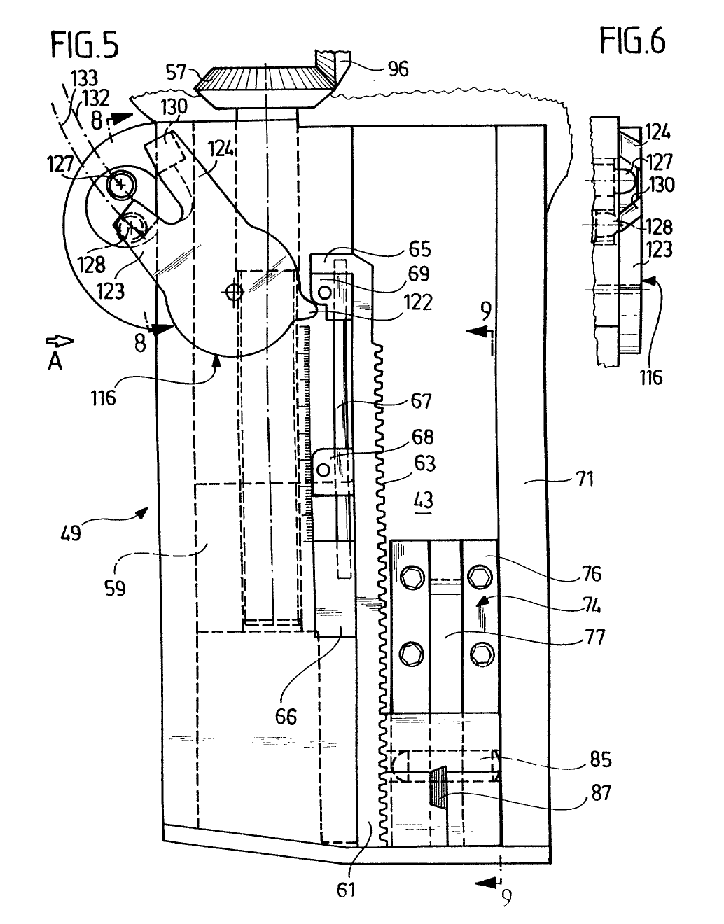

The transfer of the rotary movement of the toothed wheel 40, caused by the shaft 36, to the hollow wheel 90 of the planetary gearing is brought about via a coupling unit 98 illustrated, in particular, in FIGS. 3 and 4. The coupling unit comprises two pairs 100, 101 of gear wheels each comprising a first gear wheel 102 and 103, respectively, and a second gear wheel 105 and 106, respectively. The two gear wheels 102 and 105 as well as 103 and 106 are respectively aligned axially in relation to one another, and the first gear wheels 102 and 103, respectively, may be displaced in axial direction by means of an adjusting mechanism explained in the following in greater detail. The first and second gear wheels 102, 103 and 105, 106 bear at their front sides facing one another respective coupling elements in the form of axially projecting coupling ribs 108 so that a rotary movement of a first gear wheel 102, 103 can be transferred via the coupling ribs 108 to the corresponding second gear wheels 105 and 106, respectively.

The first gear wheel 102 of the pair 100 of gear wheels constantly meshes with the toothed wheel 40 caused to rotate by the shaft 36. If this first gear wheel 102 abuts with its coupling ribs 108 on the corresponding second gear wheel 105, the rotary movement of the toothed wheel 40 is transferred via the pair 100 of gear wheels to the hollow wheel 90 and from this to the planet pinions 94 for driving a forward motion of the tool slide 59.

In contrast to the first gear wheel 102, the first gear wheel 103 is arranged at a distance from the toothed wheel 40. The transfer of the rotary movement of the toothed wheel 40 is brought about for the pair 101 of gear wheels via an intermediate gear wheel 110 which, like the first gear wheel 102, is constantly in engagement with the toothed wheel 40. The interposition of the intermediate wheel 110 causes a reversal of the direction of rotation of the first gear wheel 103. The direction of rotation of the gear wheels is indicated in FIG. 4 by the arrows R (return movement) and V (forward movement).

The first gear wheel 103 meshing with the intermediate gear wheel 110 is likewise axially adjustable and may be coupled to the second gear wheel 106 via coupling ribs 108. This second gear wheel meshes constantly with the hollow wheel 90. If the first gear wheel 103 is, however, coupled to the second gear wheel 106 with a simultaneous decoupling of the pair 100 of gear wheels, the rotary movement of the toothed wheel 40 is transferred to the hollow wheel 90 in a reverse direction on account of the interposition of the intermediate gear wheel 110. This results in a return movement of the tool slide 59. In this respect, the transmission ratio between the first gear wheel 103 and the intermediate gear wheel 110 is selected such that the return motion of the hollow wheel 90 is brought about at a higher speed than the corresponding forward motion. Due to the decoupling of the pair 100 of gear wheels provided for the forward movement and, instead, coupling of the pair 101 of gear wheels provided for the return movement, a rapid return movement of the tool slide 59 can thus be brought about with the same direction of rotation of the shaft 36.

A switching unit 112 is provided for the coupling and decoupling of the pairs 100 and 101 of gear wheels and this unit can be actuated not only manually via a rocker arm or switching lever 114 but also automatically by the tool slide 59 via a control disk 116.

The rocker arm 114 is held in the form of a twin armed lever on the coupling unit 98 arranged stationarily on the housing 17 so as to be pivotable by means of a bearing pin 118, wherein a switching pin 119 associated with the pair 100 of gear wheels is articulatedly connected to its one arm and a second switching pin 120 associated with the pair 101 of gear wheels to its other arm. The switching pins 119 and 120 each bear at their free ends a first gear wheel 102 and 103, respectively, and may be displaced in longitudinal direction by pivoting the rocker arm 114 in such a manner that the respective first gear wheels can be displaced between a coupling position, in which they abut on the second gear wheels 105 and 106, respectively, and a decoupling position, in which they are arranged at a distance from the second gear wheels 105 and 106, respectively. The rocker arm 114 can also be brought into a central position (0 position), in which both pairs 100 and 101 of gear wheels are decoupled, and it is ensured by means of the twin-armed configuration of the rocker arm 114 that alternatively only one respective pair 100 or 101 of gear wheels can be coupled while the other pair of gear wheels is then in its decoupled position.

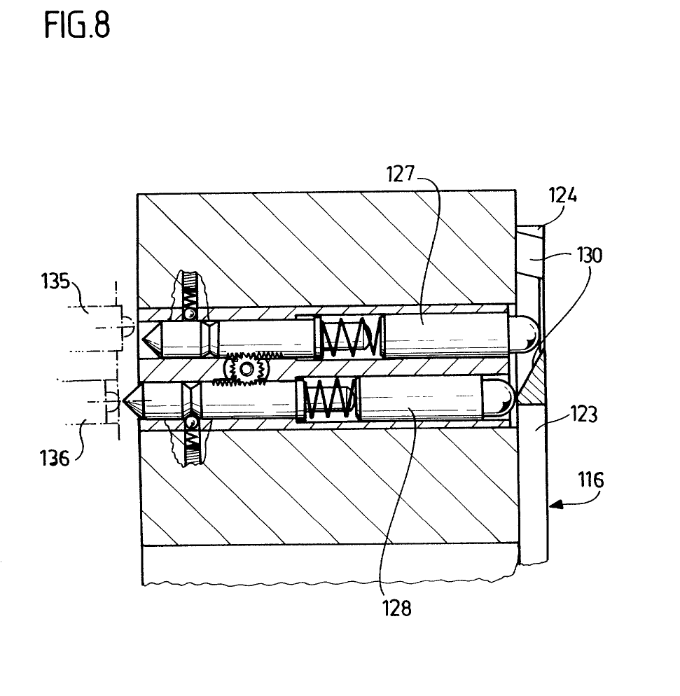

Instead of by means of a manual actuation, the switching unit 112 can also be actuated with the aid of the control disk 116. This is held on the rotary vane 49 so as to be pivotable and has in the area of the end stops 68 and 69 of the tool slide 59 a switching cam 122, against which the end stops 68 and 69 butt during a radial movement of the tool slide 59 so that when its radially outward and inward end positions are reached the tool slide 59 pivots the control disk 116. This has at its end facing away from the switching cam 122 a fork-shaped configuration with two switching prongs 123, 124 which can be abutted on switching rods 127, 128 aligned coaxially to the switching pins 119 and 120. This is clear, in particular, from FIGS. 5, 7 and 8.

The switching prongs 123, 124 each have in the area of the switching rods 127, 128 a switching surface 130 aligned at an angle to the longitudinal axis of the switching rods so that the switching rods 127 and 128 are displaced axially in the direction towards the rear wall 43 upon contact with the control disk 116. The free ends of the switching rods 127, 128 facing away from the control disk 116 are arranged in such a manner that they move along a circumcircle 132 and 133, respectively, during the rotational movement of the rotary vane 49, as illustrated in FIGS. 3, 5 and 7.

If the tool slide 59 arranged on the rotary vane 49 reaches its radially inner end position, as illustrated in FIG. 7, the outer end stop 68 butts against the switching cam 122 and so the control disk 116 is pivoted and the switching prong 124 displaces the switching rod 127 in the direction towards the rear wall 43 of the rotary vane 49. The switching rod 127 impinges on the coupling unit 98, which is arranged so as to be stationary, on account of the rotational movement of the rotary vane, namely it butts against a switching pin 135 which is arranged coaxially to the first switching pin 119 and passes through a bearing sleeve 104, on which the second gear wheel 105 is mounted. The switching pin 135 is thereby displaced axially in the direction towards the first switching pin 119 which, on the other hand, pivots the rocker arm 114 into a position, in which the pair 100 of gear wheels provided for the forward movement is decoupled while the pair 101 of gear wheels provided for the rapid return movement is coupled and thus the rapid return movement is activated.

If the tool slide 59 arranged on the rotary vane 49 reaches its radially outer end position, as illustrated in FIG. 5, after carrying out the rapid return movement, the inner end stop 69 thereby butts against the switching cam 122 and pivots the control disk 116 in such a manner that the switching prong 123 now butts against the switching rod 128 such that this is displaced in the direction towards the rear wall 43. On account of the rotation of the rotary vane 49, the switching rod 128 moves along the circumcircle 133 and thereby butts for a short time on a switching pin 136 which passes through a bearing sleeve 107, on which the second gear wheel 106 is mounted. The switching pin 136 is arranged coaxially to the second switching pin 120 so that the movement of the switching rod 128 is finally transferred to the second switching pin 120 which thereby pivots the rocker arm 114. The length of the switching pin 136 is, however, dimensioned such that the rocker arm is pivoted via the second switching pin 120 only to such an extent that it takes up its neutral position, in which not only the pair 101 of gear wheels provided for the rapid return movement but also the pair 100 of gear wheels used for the forward movement are decoupled. As a result, it is ensured that the tool slide 59, after carrying out a rapid return movement, does not automatically carry out a renewed forward movement but is first of all stopped. As a result, an operator has the chance to advance the housing 17 with the drive unit 21 and the shaft 36 as well as the coupling unit 98 and the rotary unit 42 in an axial direction along the mast 26 contrary to the spring force of the spiral spring 32 in the direction towards the tube 28 so that, subsequently, a renewed forward movement can be carried out by way of mechanical actuation of the rocker arm 114. The axial advancing of the device may be brought about in a known manner by means of crank handles 139 which are arranged on the end of the mast 26 facing the drive unit 21. The inside diameter or the outside diameter of the tube 28 can also be turned by means of the crank handles 139. For this purpose, it is merely necessary to pivot the rocker arm 114 into its neutral position so that the radial movement of the tool slide 59 is interrupted whereas the rotational movement of the rotary vanes 49, 50 continues. The tube 28 can now be machined on the outside or inside by means of manual advancing of the device.

Alternatively to a manual advancing of the device, it could also be provided for an additional drive, for example, an additional compressed air or electric motor to be used for the axial advancing. This can be activated due to actuation of the switching rod 128. As a result, an automatic axial advancing could be brought about after a rapid return movement has been completed in order to carry out a renewed forward movement. In this connection, it would also be conceivable to use the drive unit 21 not only for the continuous radial movement of the tool slide as well as the rotational movement of the rotary vanes 49 and 50 but also to carry out the axial advancing via a separate gear means, in addition.

It is clear from the aforesaid that welding joints of the most varied configurations can be generated with the illustrated embodiment within a short time and with a high surface quality on account of the simultaneous use of two cutting tools which are moved radially from the outside to the inside continuously and guided in a copying unit.

1. Device for the machining of the ends of tubes for producing a welding joint comprising a housing adapted to be secured on the end of the tube to be machined, a rotatingly drivable shaft being mounted on said housing, and comprising a rotary unit non-rotatably arranged on the shaft with a tool slide adjustable radially, transversely to the longitudinal axis of the shaft, a cutting plate being held on said tool slide for removing material from the front end of the tube, wherein the tool slide is adjustable continuously in a radial direction, wherein the radial adjustment of the tool slide is coupled via gear means to the rotary movement of the shaft, and wherein the cutting plate is held on the tool slide so as to be adjustable axially, parallel to the longitudinal axis of the shaft.

2. Device as defined in claim 1, wherein the device has a copying unit forming an automatic guide means for the cutting plate.

3. Device as defined in claim 2, wherein the copying unit is held on the rotary unit so as to be interchangeable.

4. Device as defined in claim 2, wherein the cutting plate is held on the copying unit so as to be interchangeable.

5. Device as defined in claim 1, wherein the tool slide has a sliding guide means, the cutting plate being displaceable in axial direction along said guide means.

6. Device as defined in claim 5, wherein the sliding guide means comprises groove teeth.

7. Device as defined in claim 1, wherein the tool slide is held on a spindle rotatingly drivable by the shaft so as to be radially displaceable.

8. Device as defined in claim 1, wherein the gear means comprise a switching unit for selectively switching the radial movement of the tool slide between a forward movement during the machining of the end of the tube and a rapid return movement for returning to the initial position.

9. Device as defined in claim 8, wherein the switching unit has a manually actuatable switching lever.

10. Device as defined in claim 8, wherein the switching unit comprises a control device actuatable automatically by the tool slide upon reaching its end position.

11. Device as defined in claim 10, wherein the control device is designed as a pivotable control disk.

12. Device as defined in claim 10, wherein a stop is held on the tool slide, the control device abutting on said stop and said stop being held so as to be adjustable for setting a path of adjustment of the tool slide.

13. Device as defined in claim 1, wherein the gear means comprise a planetary gearing with a planet pinion for driving the tool slide as well as a coupling unit for coupling the rotary movement of the shaft to the movement of the planetary gearing.

14. Device as defined in claim 13, wherein the planetary gearing comprises a rotatably arranged hollow wheel, the planet pinion rolling along said hollow wheel and said hollow wheel being drivable by the shaft via the coupling unit.

15. Device as defined in claim 13, wherein for generating a forward motion of the tool slide the coupling unit comprises a pair of gear wheels with first and second gear wheels couplable to one another and being in operative connection with the shaft and with the planetary gearing, respectively.

16. Device as defined in claim 13, wherein for generating a return motion of the tool slide the coupling unit has an additional pair of gear wheels with first and second gear wheels couplable to one another and being in operative connection with the shaft and the planetary gearing, respectively, wherein an intermediate gear wheel is used for one of the gear wheels for the operative connection.

17. Device as defined in claim 15, wherein the gear wheels of the pair of gear wheels are couplable to one another via an overload coupling, wherein the overload coupling releases the coupling of the two gear wheels when an overload occurs during the adjustment of the tool slide.

18. Device as defined in claim 15, wherein the gear wheels of the pair of gear wheels are arranged axially one behind the other, wherein one gear wheel is arranged so as to be axially adjustable and is adapted to be brought to a distance from the corresponding gear wheel.

19. Device as defined in claim 1, wherein the device comprises a drive unit for driving the shaft.

20. Device as defined in claim 19, wherein the drive unit has a compressed air motor or an electric motor.

21. Device as defined in claim 1, wherein at least two tool slides each having a cutting plate are held on the rotary unit so as to be radially adjustable.

22. Device as defined in claim 1, wherein the housing is adapted to be secured on the end of the tube so as to be axially biased contrary to the action of a spring force.

23. Device as defined in claim 1, wherein the housing is held so as to be axially adjustable on a mast adapted to be secured on the tube to be machined, wherein a motor drive is provided for an axial advancing movement of the housing.
